(19) United States
(12) Patent Application Publication
(10) Pub. No.: US 2026/0106083 A1
(43) Pub. Date: Apr. 16, 2026

(54) MULTILAYER CERAMIC CAPACITOR

(71) Applicant: SAMSUNG ELECTRO-MECHANICS CO., LTD., Suwon-si (KR)

(72) Inventors: Cheolwoo Park, Suwon-si (KR); Junil Kang, Suwon-si (KR); Seung Jun Lee, Suwon-si (KR); Heejung Jung, Suwon-si (KR); Yumi Jo, Suwon-si (KR); Hongseok Kim, Suwon-si (KR)

(73) Assignee: SAMSUNG ELECTRO-MECHANICS CO., LTD., Suwon-si (KR)

(21) Appl. No.: 19/058,653

(22) Filed: Feb. 20, 2025

(30) Foreign Application Priority Data
Oct. 15, 2024 (KR) 10-2024-0140186

(51) Int. Cl. H01G 4/30; H01G 4/012; H01G 4/232

(52) U.S. Cl. CPC H01G 4/30; H01G 4/012; H01G 4/2325

(57) ABSTRACT

A multilayer ceramic capacitor includes a body comprising a first surface and a second surface opposite to each other in a first direction, a plurality of internal electrodes stacked with a dielectric layer interposed therebetween in the first direction, an external electrode disposed on the outside of the body, a first outer region that faces the first surface, a second outer region that faces the second surface, an inner region between the first outer region and the second outer region, wherein an internal electrode in the first outer region and an internal electrode in the second outer region are thinner than an internal electrode in the inner region, and a dielectric layer in the first outer region and a dielectric layer in the second outer region are thicker than a dielectric layer in the inner region.

### RELATED APPLICATIONS

This application claims priority to and the benefit of Korean Patent Application No. 10-2024-0140186 filed in the Korean Intellectual Property Office on Oct. 15, 2024, the entire contents of which are incorporated herein by reference.

### BACKGROUND

### 1. Field

The present disclosure relates to a multilayer ceramic capacitor.

### 2. Description of the Related Art

Electronic components using ceramic materials include capacitors, inductors, piezoelectric devices, varistors, thermistors, and so on. Among these ceramic electronic components, multilayer ceramic capacitors (MLCCs) have the advantage that they are small, high capacity is guaranteed, and it is easy to mount them, and thus can be used in a variety of electronic devices.

A multilayer ceramic capacitor may include a body that includes a plurality of dielectric layers and a plurality of internal electrodes, and external electrodes that are disposed on the outside of the body and are connected to the internal electrodes. When a crack is generated in a dielectric layer or electrical breakdown occurs, the multilayer ceramic capacitor may fail.

### SUMMARY

The present disclosure attempts to provide a multilayer ceramic capacitor capable of preventing generation of a crack in a dielectric layer and electrical breakdown.

A multilayer ceramic capacitor according to some embodiments of the present disclosure may include a body that has a first surface and a second surface opposite to each other in a first direction and includes a plurality of internal electrodes stacked with a dielectric layer interposed therebetween in the first direction, and an external electrode that is disposed on the outside of the body, and the body may include a first outer region that faces the first surface, a second outer region that faces the second surface, and an inner region between the first outer region and the second outer region, and an internal electrode in the first outer region and an internal electrode in the second outer region may be thinner than an internal electrode in the inner region, and a dielectric layer in the first outer region and a dielectric layer in the second outer region may be thicker than a dielectric layer in the inner region.

A ratio of the thickness of the dielectric layer in the first outer region to the thickness of the dielectric layer in the inner region may be greater than 1 and equal to or smaller than 3.

A ratio of the thickness of the dielectric layer in the second outer region to the thickness of the dielectric layer in the inner region may be greater than 1 and equal to or smaller than 3.

The first outer region may include a first internal electrode closest to the first surface, a second internal electrode facing the first internal electrode, and a first dielectric layer between the first internal electrode and the second internal electrode, and the first dielectric layer may be thicker than the dielectric layer in the inner region.

The second outer region may include a third internal electrode closest to the second surface, a fourth internal electrode facing the third internal electrode, and a second dielectric layer between the third internal electrode and the fourth internal electrode, and the second dielectric layer may be thicker than the dielectric layer in the inner region.

The number of internal electrodes in the first outer region may be smaller than the number of internal electrodes in the inner region.

The number of internal electrodes in the second outer region may be smaller than the number of internal electrodes in the inner region.

The sum of the number of internal electrodes in the first outer region and the number of internal electrodes in the second outer region may be smaller than the number of internal electrodes in the inner region.

The body may further include a first cover layer that is disposed outside the first outer region in the first direction; and a second cover layer that is disposed outside the second outer region in the first direction.

The multilayer ceramic capacitor may further include a plating layer that covers the external electrode.

The plating layer may include a first layer that covers the external electrode; a second layer that covers the first layer; and a third layer that covers the second layer.

The first layer may contain nickel (Ni), the second layer may contain copper (Cu), and the third layer may contain tin (Sn).

According to the multilayer ceramic capacitor according to the embodiment, the thickness of the dielectric layer in the outer region of the body in the stacking direction may be set so as to be larger than the thickness of the dielectric layer of the inner region, thereby preventing crack generation and electrical breakdown.

### BRIEF DESCRIPTION OF THE DRAWINGS

FIG. 1 is a perspective view schematically illustrating a multilayer ceramic capacitor according to an embodiment.

FIG. 2 is a cross-sectional view taken along line I-I′ of FIG. 1.

FIG. 3 is a cross-sectional view taken along line II-II′ of FIG. 1.

FIG. 4 is an enlarged view illustrating region A of FIG. 2.

FIG. 5 is an enlarged view illustrating region B of FIG. 2.

FIG. 6 is an enlarged view illustrating region C of FIG. 2.

### DETAILED DESCRIPTION

Hereinafter, some embodiments of the present disclosure will be described in detail with reference to the accompanying drawings such that those skilled in the art can easily implement them. The drawings and description are to be regarded as illustrative in nature and not restrictive. Like reference numerals designate like elements throughout the specification. Further, some constituent elements in the drawing may be exaggerated, omitted, or schematically illustrated, and a size of each constituent element does not reflect the actual size entirely.

The accompanying drawings are provided for helping to easily understand embodiments disclosed in the present specification, and the technical spirit disclosed in the present specification is not limited by the accompanying drawings, and it will be appreciated that the disclosure includes all of the modifications, equivalent matters, and substitutes included in the spirit and the technical scope of the disclosure.

Terms including an ordinary number, such as first and second, are used for describing various constituent elements, but the constituent elements are not limited by the terms. The terms are used only to discriminate one constituent element from another constituent element.

Further, it will be understood that when an element such as a layer, film, region, or substrate is referred to as being “on” another element, it can be directly on the other element or intervening elements may also be present. In contrast, when an element is referred to as being “directly on” another element, there are no intervening elements present. Further, when an element is “on” a reference portion, the element is located above or below the reference portion, and it does not necessarily mean that the element is located “above” or “on” in a direction opposite to gravity.

In the present application, it will be appreciated that terms “including” and “having” are intended to designate the existence of characteristics, numbers, steps, operations, constituent elements, and components described in the specification or a combination thereof, and do not exclude a possibility of the existence or addition of one or more other characteristics, numbers, steps, operations, constituent elements, and components, or a combination thereof in advance. Therefore, unless explicitly described to the contrary, the word “comprise,” and variations such as “comprises” or “comprising,” will be understood to imply the inclusion of stated elements but not the exclusion of any other elements.

Further, in the entire specification, when it is referred to as “on a plane”, it means when a target part is viewed from above, and when it is referred to as “on a cross-section,” it means when the cross-section obtained by cutting a target part vertically is viewed from the side.

Further, throughout the specification, when it is referred to as “connected”, this does not only mean that two or more constituent elements are directly connected, but may mean that two or more constituent elements are indirectly connected through another constituent element, are physically connected, electrically connected, or are integrated even though two or more constituent elements are referred as different names depending on a location and a function.

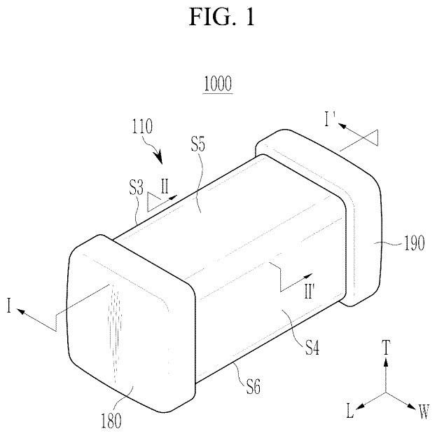

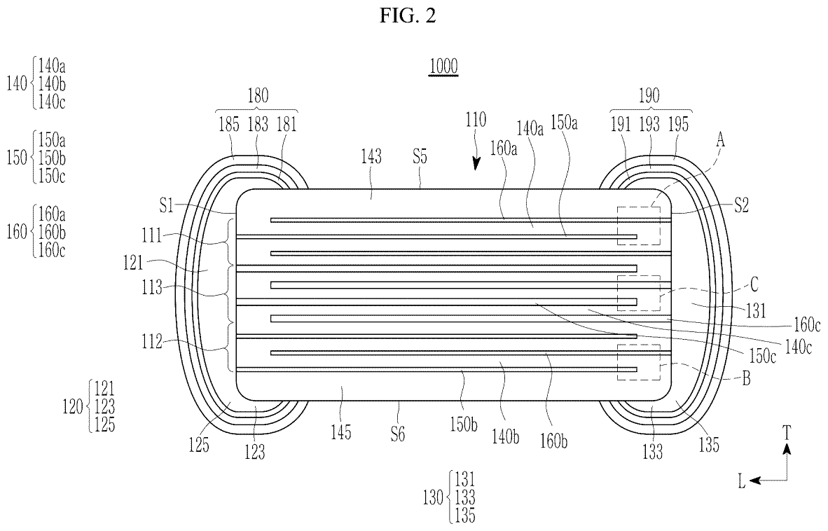

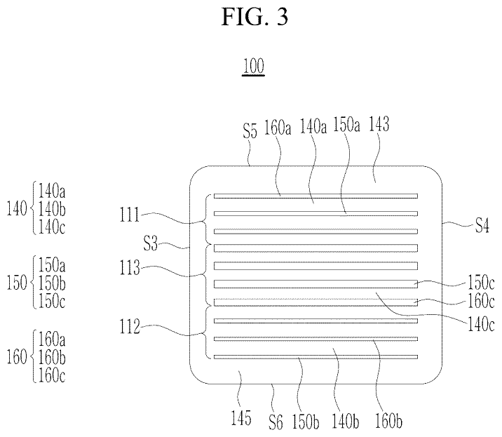

FIG. 1 is a perspective view schematically illustrating a multilayer ceramic capacitor according to an embodiment, FIG. 2 is a cross-sectional view taken along line I-I′ of FIG. 1, and FIG. 3 is a cross-sectional view taken along line II-II′ of FIG. 1.

Referring to FIGS. 1, 2, and 3, a multilayer ceramic capacitor 1000 according to the present embodiment includes a body 110, a first external electrode 120, a second external electrode 130, a plurality of dielectric layers 140, a plurality of first internal electrodes 150, and a plurality of second internal electrodes 160.

First, to clearly describe the present embodiment, directions are defined as follows: the L axis, the W axis, and the T axis shown in the drawings represent axes indicating the length direction, width direction, and thickness direction of the multilayer ceramic capacitor 1000, respectively.

The thickness direction (T-axis direction) may be a direction perpendicular to wide surfaces (main surfaces) of sheet-shaped constituent elements. For example, the thickness direction (T-axis direction) may be used as the same concept as the direction in which the dielectric layers 140 are stacked.

The length direction (L-axis direction) may be a direction parallel with wide surfaces (main surfaces) of constituent elements having sheet-like shapes, and be a direction that intersects (or is orthogonal to) the thickness direction (T-axis direction). For example, the length direction (L-axis direction) may be the direction in which the first external electrode 120 and the second external electrode 130 face each other.

The width direction (W-axis direction) may be a direction parallel with wide surfaces (main surfaces) of constituent elements having sheet shapes, and be a direction that intersects (is orthogonal to) both of the thickness direction (T-axis direction) and the length direction (L-axis direction).

The body 110 may have a roughly hexahedral shape, but the present embodiment is not limited thereto. Due to shrinkage during sintering, the body 110 may have a substantially hexahedral shape, although not a perfect hexahedral shape. For example, the body 110 may have a substantially cuboid shape having rounded edges or vertices.

In the present embodiment, for ease of explanation, surfaces facing each other in the length direction (L-axis direction) are defined as a first surface S1 and a second surface S2, and surfaces that face each other in the width direction (W-axis direction) and connect the first surface S1 and the second surface S2 are defined as a third surface S3 and a fourth surface S4, and surfaces that face each other in the thickness direction (T-axis direction) and connect the first surface S1 and the second surface S2 are defined as a fifth surface S5 and a sixth surface S6.

Accordingly, a first direction in which the first surface S1 and the second surface S2 face each other may be the length direction (L-axis direction), and a second direction and a third direction which are perpendicular to the first direction and are perpendicular to each other may be the thickness direction (T-axis direction) and the width direction (W-axis direction), respectively, or may be the width direction (W-axis direction) and the thickness direction (T-axis direction), respectively.

In an optical microscope or scanning electron microscope (SEM) photograph of the lengthwise (L-axis direction) and thickness-wise (T-axis direction) cross section of the body 110 at the center in the width direction (W-axis direction), the length of the body 110 may refer to the maximum of the lengths of a plurality of line segments, each of which connects two outermost boundary lines of the body 110 facing each other in the length direction (L-axis direction), shown in the above-mentioned cross section photograph, and is parallel with the length direction (L-axis direction). Alternatively, the length of the body 110 may refer to the minimum of the lengths of a plurality of line segments, each of which connects two outermost boundary lines of the body 110 facing each other in the length direction (L-axis direction), shown in the above-mentioned cross section photograph and is parallel with the length direction (L-axis direction). Or, the length of the body 110 may refer to the arithmetic average of the lengths of at least two line segments of a plurality of line segments, each of which connects two outermost boundary lines of the body 110 facing each other in the length direction (L-axis direction), shown in the above-mentioned cross section photograph and is parallel with the length direction (L-axis direction).

In an optical microscope photograph or scanning electron microscope (SEM) photograph of the lengthwise (L-axis direction) and thickness-wise (T-axis direction) cross section of the body 110 at the center in the width direction (W-axis direction), the thickness of the body 110 may refer to the maximum of the lengths of a plurality of line segments, each of which connects two outermost boundary lines of the body 110 facing each other in the thickness direction (T-axis direction), shown in the above-mentioned cross section photograph, and is parallel with the thickness direction (T-axis direction). Alternatively, the thickness of the body 110 may refer to the minimum of the lengths of a plurality of line segments, each of which connects two outermost boundary lines of the body 110 facing each other in the thickness direction (T-axis direction), shown in the above-mentioned cross section photograph and is parallel with the thickness direction (T-axis direction). Alternatively, the thickness of the body 110 may refer to the arithmetic average of the lengths of at least two line segments of a plurality of line segments, each of which connects two outermost boundary lines of the body 110 facing each other in the thickness direction (T-axis direction), shown in the above-mentioned cross section photograph and is parallel with the thickness direction (T-axis direction).

In an optical microscope photograph or scanning electron microscope (SEM) photograph of the lengthwise (L-axis direction) and width-wise (W-axis direction) cross section of the body 110 at the center in the thickness direction (T-axis direction), the width of the body 110 may refer to the maximum of the lengths of a plurality of line segments, each of which connects two outermost boundary lines of the body 110 facing each other in the width direction (W-axis direction), shown in the above-mentioned cross section photograph, and is parallel with the width direction (W-axis direction). Alternatively, the width of the body 110 may refer to the minimum of the lengths of a plurality of line segments, each of which connects two outermost boundary lines of the body 110 facing each other in the width direction (W-axis direction), shown in the above-mentioned cross section photograph and is parallel with the width direction (W-axis direction). Alternatively, the width of the body 110 may refer to the arithmetic average of the lengths of at least two line segments of a plurality of line segments, each of which connects two outermost boundary lines of the body 110 facing each other in the width direction (W-axis direction), shown in the above-mentioned cross section photograph and is parallel with the width direction (W-axis direction).

The body 110 may include a plurality of dielectric layers 140 stacked in the thickness direction (T-axis direction). The boundaries between the dielectric layers 140 may be unclear. For example, the boundaries between the dielectric layers 140 may be so unclear that it is difficult to see them without the use of a scanning electron microscope (SEM), and the plurality of dielectric layers 140 may look like an integrated structure.

The first internal electrodes 150 and the second internal electrodes 160 may be alternately stacked with the dielectric layers 140 interposed therebetween. This stack structure may be repeated inside the body 110, and the internal electrode closest to the fifth surface S5 of the body 110 may be a first internal electrode 150 or may be a second internal electrode 160. Similarly, the internal electrode closest to the sixth surface S6 of the body 110 may be a first internal electrode 150 or may be a second internal electrode 160.

The first internal electrodes 150 and the second internal electrodes 160 have different polarities, and may be electrically insulated from each other by the dielectric layers 140 disposed therebetween.

The first internal electrodes 150 and the second internal electrodes 160 may be formed on the surfaces of the dielectric layers 140 by printing using conductive paste containing a metal. For example, the internal electrodes may be formed on the surfaces of the dielectric layers by screen printing or gravure printing using conductive paste containing nickel (Ni) or a nickel (Ni) alloy. However, the present embodiment is not limited thereto.

When a voltage is applied between the first external electrode 120 and the second external electrode 130, charge is accumulated between the first internal electrodes 150 and the second internal electrodes 160. In other words, capacitance can be obtained between the first internal electrodes 150 electrically coupled to the first external electrode 120 and the second internal electrodes 160 electrically coupled to the second external electrode 130. The capacitance of the multilayer ceramic capacitor 1000 is proportional to the overlapping area of the first internal electrodes 150 and the second internal electrodes 160 overlapping each other in the thickness direction (T-axis direction).

In other words, the multilayer ceramic capacitor 1000 may include an active region and margin regions. The active region may refer to the region where the first internal electrodes 150 and the second internal electrodes 160 overlap along the thickness direction (T-axis direction), and the margin regions may refer to the region between the active region and the first surface S1 of the body 110 and the region between the active region and the second surface S2 of the body 110. Meanwhile, the region between the active region and the third surface S3 of the body 110 and the region B the active region and the fourth surface S4 of the body 110 also may be referred to as margin regions.

On the outer sides of the active region in the thickness direction (T-axis direction), a first cover layer 143 and a second cover layer 145 may be disposed.

The first cover layer 143 is disposed between the fifth surface S5 of the body 110 and the internal electrode closest thereto. The second cover layer 145 is disposed between the sixth surface S6 of the body 110 and the internal electrode closest thereto.

In other words, inside the body 110, the first cover layer 143 may be disposed on the uppermost internal electrode, and the second cover layer 145 may be disposed below the lowermost internal electrode. The first cover layer 143 and the second cover layer 145 may have the same composition as that of the dielectric layers 140. The first cover layer 143 and the second cover layer 145 may be formed by stacking one or more dielectric layers on the outer surface of the uppermost internal electrode and the outer surface of the lowermost internal electrode, respectively. Meanwhile, the first cover layer 143 and the second cover layer 145 may have a composition different from that of the dielectric layer 140.

The first cover layer 143 and the second cover layer 145 may serve to prevent damage to the first internal electrodes 150 and the second internal electrodes 160 by physical or chemical stress.

The dielectric layers 140 may contain a ceramic material with a high dielectric constant. For example, the ceramic material may contain dielectric ceramic at least one selected from the group consisting of BaTiO₃, CaTiO₃, SrTiO₃, and CaZrO₃. Also, the dielectric layers may further contain an auxiliary component at least one selected from the group consisting of a manganese (Mn) compound, an iron (Fe) compound, a chromium (Cr) compound, a cobalt (Co) compound, and a nickel (Ni) compound, etc., in addition to the ceramic material. For example, the dielectric layers may comprise at least one selected from the group consisting of (Ba₁₋ₓCaₓ)TiO₃ (wherein 0<x<1), Ba(Ti_{1-y}Ca_{y})O₃ (wherein 0<y<1), (Ba₁₋ₓCaₓ)(Ti_{1-y}Zr_{y})O₃ (wherein 0<x<1 and 0<y<1), and Ba(Ti_{1-y}Zr_{y})O₃ (wherein 0<y<1), or the like, i.e., BaTiO₃ doped with calcium (Ca), zirconium (Zr), etc., but the disclosure is not limited thereto.

Further, the dielectric layers 140 may further contain one or more of ceramic additives, organic solvents, plasticizers, binders, and dispersing agents. Examples of the ceramic additives may include transition metal oxides or carbides, rare earth elements, magnesium (Mg), aluminum (Al), etc.

The first external electrode 120 and the second external electrode 130 are disposed on the outside of the body 110.

The first external electrode 120 may be disposed on the first surface S1 of the body 110 and extend onto the third surface S3, the fourth surface S4, the fifth surface S5, and the sixth surface S6. The second external electrode 130 may be disposed on the second surface S2 of the body 110 and extend onto the third surface S3, the fourth surface S4, the fifth surface S5, and the sixth surface S6. In other embodiments, the first external electrode 120 and the second external electrode 130 may extend onto a portion of at least one surface of the fifth surface S5 and the sixth surface S6.

The first external electrode 120 may include a first contact portion 121, a first band portion 123, and a first edge portion 125.

The first contact portion 121 may be a portion that covers the first surface S1 of the body 110 and is in contact with the plurality of first internal electrodes 150 to be electrically connected to them.

In other embodiments, the first contact portion 121 may cover a portion of the first surface S1 of the body 110.

The first band portion 123 extends from the first contact portion 121 to cover at least a portion of the third surface S3, fourth surface S4, fifth surface S5, and sixth surface S6 of the body 110. The first band portion 123 may help to make the first external electrode 120 be more firmly fixed to the body 110.

The first edge portion 125 may be a portion that connects the first contact portion 121 and the first band portion 123.

The second external electrode 130 may include a second contact portion 131, a second band portion 133, and a second edge portion 135.

The second contact portion 131 may be a portion that covers the second surface S2 of the body 110 and is in contact with the plurality of second internal electrodes 160 to be electrically connected to them.

In other embodiments, the second contact portion 131 may cover a portion of the second surface S2 of the body 110.

The second band portion 133 extends from the second contact portion 131 to cover at least a portion of the third surface S3, fourth surface S4, fifth surface S5, and sixth surface S6 of the body 110. The second band portion 133 may help to make the second external electrode 130 be more firmly fixed to the body 110.

The second edge portion 135 may be a portion that connects the second contact portion 131 and the second band portion 133.

As seen in an optical microscope or scanning electron microscope (SEM) photograph of the lengthwise (L-axis direction) and thickness-wise (T-axis direction) cross section of the multilayer ceramic capacitor 1000 at the center in the width direction (W-axis direction), in the multilayer ceramic capacitor 1000 shown in the above-mentioned photograph, the first contact portion 121 and the second contact portion 131 may have shapes generally parallel with the thickness direction (T-axis direction), and the first band portion 123 and the second band portion 133 may have shapes generally parallel with the length direction (L-axis direction), and the first edge portion 125 and the second edge portion 135 may have curved shapes. The curved shape described above may be a curved shape having a tangent whose slope changes from a direction parallel to the thickness direction (T-axis direction) to a direction parallel to the length direction (L-axis direction) (or vice versa).

The first external electrode 120 and the second external electrode 130 may include a conductive material at least one selected from the group consisting of copper (Cu), aluminum (Al), silver (Ag), tin (Sn), gold (Au), nickel (Ni), lead (Pb), chromium (Cr), titanium (Ti), and an alloy thereof, but are not limited thereto.

As another example, the first external electrode 120 and the second external electrode 130 may contain a metal and glass. The metal may include at least one selected from the group consisting of, for example, a conductive metal containing copper (Cu), nickel (Ni), tin (Sn), palladium (Pd), platinum (Pt), gold (Au), silver (Ag), tungsten (W), titanium (Ti), lead (Pb), and an alloy thereof. The glass component which is contained in the external electrodes may include a composition containing oxides. The glass component may contain at least one selected from the group consisting of, for example, a silicon oxide, a boron oxide, an aluminum oxide, a transition metal oxide, an alkali metal oxide, an alkaline earth metal oxide, and a combination thereof. Here, the transition metal may include at least one selected from the group consisting of zinc (Zn), titanium (Ti), copper (Cu), vanadium (V), manganese (Mn), iron (Fe), and nickel (Ni), and the alkali metal may include at least one selected from the group consisting of lithium (Li), sodium (Na), or potassium (K), and the alkaline earth metal may be selected from magnesium (Mg), calcium (Ca), strontium (Sr), and barium (Ba). The method of forming these external electrodes are not particularly limited. For example, the external electrodes may be formed by dipping the body in a conductive paste containing metal and glass, or a conductive paste may be printed on the surface of the body by screen printing, gravure printing, or the like to form the external electrodes. Alternatively, various methods such as a method of forming the external electrodes by applying a conductive paste to the surface of the body or by transferring a dry film, made by drying the conductive paste, onto the body may be used.

Meanwhile, the first external electrode 120 may be covered by a first plating layer 180, and the second external electrode 130 may be covered by a second plating layer 190.

Both of the first plating layer 180 and the second plating layer 190 may include a plurality of layers. For example, the first plating layer 180 may include a first layer 181 that covers the first external electrode 120, a second layer 183 that covers the first layer 181, and a third layer 185 that covers the second layer 183. The first layer may contain nickel (Ni), the second layer may contain copper (Cu), and the third layer may contain tin (Sn); however, the present embodiment is not limited thereto.

Also, the second plating layer 190 may include a first layer 191 that covers the second external electrode 130, a second layer 193 that covers the first layer 191, and a third layer 195 that covers the second layer 193. The first layer 191 may contain nickel (Ni), the second layer 193 may contain copper (Cu), and the third layer 195 may contain tin (Sn); however, the present embodiment is not limited thereto.

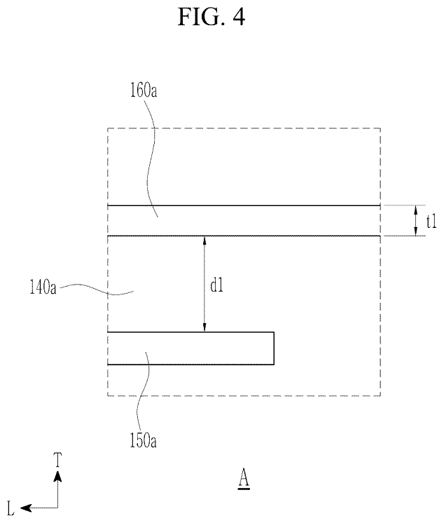

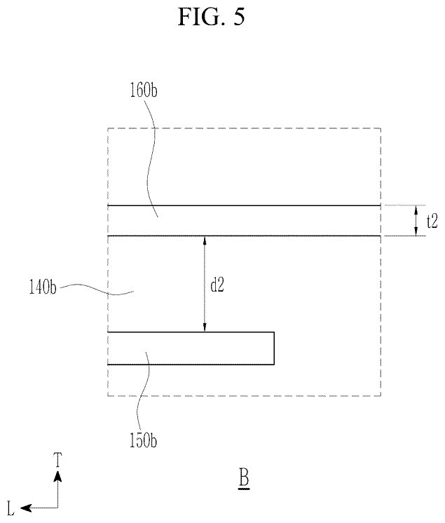

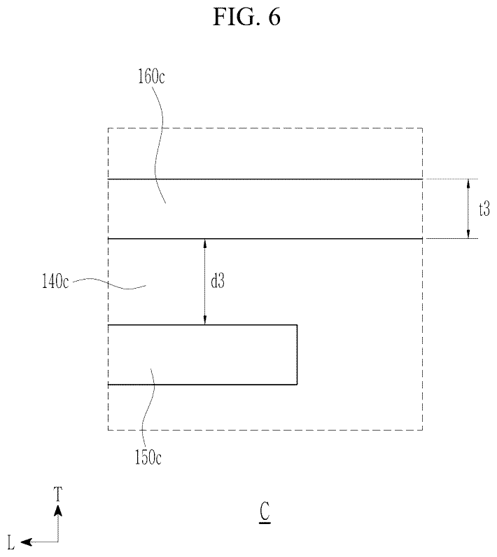

FIG. 4 is an enlarged view illustrating region A of FIG. 2, FIG. 5 is an enlarged view illustrating region B of FIG. 2, and FIG. 6 is an enlarged view illustrating region C of FIG. 2.

Referring to FIGS. 2, 4, 5, and 6, the body 110 may include a first outer region 111, a second outer region 112, and an inner region 113 in the thickness direction (the T-axis direction).

The first outer region 111 may be a region which faces the fifth surface S5 of the body 110 and may be in contact with the first cover layer 143.

The first outer region 111 may include a first internal electrode 150a, a second internal electrode 160a, and a dielectric layer 140a.

The first internal electrode 150a may be the internal electrode closest to the fifth surface S5 of the body 110, and the second internal electrode 160a may be an internal electrode facing the first internal electrode 150a. The dielectric layer 140a may be disposed between the first internal electrode 150a and the second internal electrode 160a.

In FIGS. 2 and 3, it is shown that the first outer region 111 includes three internal electrodes and three dielectric layers; however, the present embodiment is not limited thereto.

The second outer region 112 may be a region which faces the sixth surface S6 of the body 110 and may be in contact with the second cover layer 145.

The second outer region 112 may include a first internal electrode 150b, a second internal electrode 160b, and a dielectric layer 140b.

The first internal electrode 150b may be the internal electrode closest to the sixth surface S6 of the body 110, and the second internal electrode 160b may be an internal electrode facing the first internal electrode 150b. The dielectric layer 140b may be disposed between the first internal electrode 150b and the second internal electrode 160b.

In FIGS. 2 and 3, it is shown that the second outer region 112 may include three internal electrodes and three dielectric layers; however, the present embodiment is not limited thereto.

The inner region 113 may be a region between the first outer region 111 and the second outer region 112. The inner region 113 may include a first internal electrode 150c, a second internal electrode 160c, and a dielectric layer 140c.

In FIGS. 2 and 3, it is shown that the inner region 113 may include four internal electrodes and three dielectric layers; however, the present embodiment is not limited thereto.

The number of internal electrodes in the first outer region 111 may be smaller than the number of internal electrodes in the inner region 113. The number of internal electrodes in the second outer region 112 may be smaller than the number of internal electrodes in the inner region 113. Further, the sum of the number of internal electrodes in the first outer region 111 and the number of internal electrodes in the second outer region 112 may be smaller than the number of internal electrodes in the inner region 113.

The thickness t1 of the internal electrodes 150a and 160a in the first outer region 111 may be smaller than the thickness t3 of the internal electrodes 150c and 160c in the inner region 113. The thickness t2 of the internal electrodes 150b and 160b in the second outer region 112 may be smaller than the thickness t3 of the internal electrodes 150c and 160c in the inner region 113.

Here, the thickness of an internal electrode may refer to the average thickness of one internal electrode disposed between two dielectric layers. The average thickness of one internal electrode in a 10000× magnification scanning electron microscope (SEM) photograph of the length direction (L-axis direction) and thickness direction (T-axis direction) cross section of the body 110 at the center in the width direction (W-axis direction) may be an arithmetic average of the thicknesses of the internal electrode measured from 30 equally spaced points on the internal electrode in the length direction (L-axis direction) in the above-mentioned cross section photograph. These 30 points may be designated in the above-mentioned active region. By measuring each of the average thicknesses of ten (10) (or less) internal electrodes in this way and obtaining the arithmetic average of the measured values, the average thickness of the internal electrodes may be further generalized.

The dielectric layer 140a in the first outer region 111 is thicker than the dielectric layer 140c in the inner region 113.

The ratio of the thickness d1 of the dielectric layer 140a in the first outer region 111 to the thickness d3 of the dielectric layer 140c in the inner region 113, i.e., d1/d3 may be greater than 1, 1.5, 2 or 2.5 and equal to or smaller than 3, 2.5, 2, or 1.5. For example, the thickness d3 of the dielectric layer 140c in the inner region 113 may be 0.88 μm, and the thickness d1 of the dielectric layer 140a in the first outer region 111 may be 0.93 μm.

The dielectric layer 140b in the second outer region 112 may be thicker than the dielectric layer 140c in the inner region 113.

The thickness ratio of the thickness d2 of the dielectric layer 140b in the second outer region 112 to the thickness d3 of the dielectric layer 140c in the inner region 113, i.e., d2/d3 may be greater than 1, 1.5, 2 or 2.5 and equal to or smaller than 3, 2.5, 2 or 1.5. For example, the thickness d3 of the dielectric layer 140c in the inner region 113 may be 0.88 μm, and the thickness d2 of the dielectric layer 140b in the second outer region 112 may be 0.93 μm.

Here, the thickness of a dielectric layer may refer to the average thickness of one dielectric layer disposed between two internal electrodes. The average thickness of one dielectric layer in a 10000× magnification scanning electron microscope (SEM) photograph of the length direction (L-axis direction) and thickness direction (T-axis direction) cross section of the body 110 at the center in the width direction (W-axis direction) may be an arithmetic average of the thicknesses of the dielectric layer measured from 30 equally spaced points on the dielectric layer in the length direction (L-axis direction) in the above-mentioned cross section photograph. These 30 points may be designated in the above-mentioned active region. By measuring each of the average thicknesses of ten (10) (or less) dielectric layers in this way and obtaining the arithmetic average of the measured values, the average thickness of the dielectric layers may be further generalized.

Meanwhile, the dielectric layer 140a in the first outer region 111 may be thicker than the dielectric layer 140c in the inner region 113, and the thickness t1 of the internal electrodes 150a and 160a in the first outer region 111 may be smaller than the thickness t3 of the internal electrodes 150c and 160c in the inner region 113. The dielectric layer 140b in the second outer region 112 may be thicker than the dielectric layer 140c in the inner region 113, and the thickness t2 of the internal electrodes 150b and 160b in the second outer region 112 may be smaller than the thickness t3 of the internal electrodes 150c and 160c in the inner region 113. In particular, the thickness of the internal electrodes 150a and 160a in the first outer region 111 may be decreased as the thickness of the dielectric layer 140a in the first outer region 111 is increased, and the thickness of the internal electrodes 150b and 160b in the second outer region 112 may be decreased as the thickness of the dielectric layer 140b in the second outer region 112 is increased. In other words, the increase in thickness of the dielectric layer and the decrease in thickness of the internal electrodes may be offset. Accordingly, the overall thickness of the multilayer ceramic capacitor can be kept within a certain range.

In general, mainly in the dielectric layer closest to the outer surface of the multilayer ceramic capacitor in the thickness direction (the T-axis direction), cracks may be generated or electrical breakdown may occur.

According to the present embodiment, since the thicknesses of the dielectric layers in the first outer region 111 closest to the fifth surface S5 of the body 110 and the second outer region 112 closest to the sixth surface S6 of the body 110 are larger than the thickness of the dielectric layer in the inner region 113, crack generation or electrical breakdown in the dielectric layers in the first outer region 111 and the second outer region 112 can be prevented. As a result, the multilayer ceramic capacitor according to the present embodiment can have improved reliability.

### Experimental Example: Insulation Resistance of Multilayer Ceramic Capacitor

Fifty multilayer ceramic capacitors for each of Example and Comparative Example were manufactured, and then were mounted on a substrate. Then, a high-temperature load test was performed under the conditions of 125° C., 1.2 atm, 95% RH, and rated voltage application, and the failure was determined when insulation resistance became 10 kΩ or less. From these failure times, each mean time to failure (MTTF) was calculated. The results are summarized in Table 1.

TABLE 1

| | Thickness (μm) of Dielectric Layer | | | Mean Time |
|---|---|---|---|---|
| | first outer | inner | second outer | to Failure |
| | region | region | region | (hours) |
| Example | 0.93 | 0.88 | 0.93 | 11.83 |

| | | Mean Time |
|---|---|---|
| | Thickness (μm) of | to Failure |
| | Dielectric Layer | (hours) |
| Comparative | 0.88 | 8.2 |
| Example | | |

Referring to Table 1, the mean time to failure of the multilayer ceramic capacitors according to Example was 11.83 hours, and the mean time to failure of the multilayer ceramic capacitors according to Comparative Example was 8.2 hours. In other words, the mean time to failure of the multilayer ceramic capacitors according to Example was longer than the mean time to failure of the multilayer ceramic capacitors according to Comparative Example. This seems to be because the dielectric layers of the first outer regions and the second outer regions were thicker than the dielectric layers of the inner regions, and thus crack generation in the dielectric layers or electrical breakdown was prevented.

While this disclosure has been described in connection with what is presently considered to be practical embodiments, it is to be understood that the disclosure is not limited to the disclosed embodiments. On the contrary, it is intended to cover various modifications and equivalent arrangements included within the spirit and scope of the appended claims.

### DESCRIPTION OF SYMBOLS

1000: Multilayer Ceramic Capacitor
110: Body
120: First External Electrode
130: Second External Electrode
140, 140a, 140b, 140c: Dielectric Layer
143: First Cover Layer
145: Second Cover Layer
150, 150a, 150b, 150c: First Internal Electrode
160, 160a, 160b, 160c: Second Internal Electrode
180: First Plating Layer
190: Second Plating Layer
181, 191: First Layer
183, 193: Second Layer
185, 195: Third Layer

What is claimed is:

1. A multilayer ceramic capacitor comprising:
a body comprising a first surface and a second surface opposite to each other in a first direction, and a plurality of internal electrodes stacked with a plurality of dielectric layers interposed therebetween in the first direction; and
an external electrode disposed on the outside of the body,
wherein the body includes:
a first outer region facing the first surface;
a second outer region facing the second surface; and
an inner region between the first outer region and the second outer region,
wherein the plurality of internal electrodes include an internal electrode in the first outer region, an internal electrode in the second outer region, and an internal electrode in the inner region, and
wherein the internal electrode in the first outer region and the internal electrode in the second outer region are thinner than the internal electrode in the inner region, and
wherein the plurality of dielectric layers include a dielectric layer in the first outer region, a dielectric layer in the second outer region, and a dielectric layer in the inner region, and
wherein the dielectric layer in the first outer region and the dielectric layer in the second outer region are thicker than the dielectric layer in the inner region.

2. The multilayer ceramic capacitor of claim 1, wherein:
a ratio of a thickness of the dielectric layer in the first outer region to a thickness of the dielectric layer in the inner region is greater than 1 and equal to or smaller than 3.

3. The multilayer ceramic capacitor of claim 2, wherein:
a ratio of a thickness of the dielectric layer in the second outer region to the thickness of the dielectric layer in the inner region is greater than 1 and equal to or smaller than 3.

4. The multilayer ceramic capacitor of claim 1, wherein:
the first outer region includes a first internal electrode closest to the first surface, a second internal electrode facing the first internal electrode, and a first dielectric layer between the first internal electrode and the second internal electrode, and
the first dielectric layer is thicker than the dielectric layer in the inner region.

5. The multilayer ceramic capacitor of claim 4, wherein:
the second outer region includes a third internal electrode closest to the second surface, a fourth internal electrode facing the third internal electrode, and a second dielectric layer between the third internal electrode and the fourth internal electrode, and
the second dielectric layer is thicker than the dielectric layer in the inner region.

6. The multilayer ceramic capacitor of claim 1, wherein:
a number of internal electrodes in the first outer region is smaller than a number of internal electrodes in the inner region.

7. The multilayer ceramic capacitor of claim 6, wherein:
a number of internal electrodes in the second outer region is smaller than the number of internal electrodes in the inner region.

8. The multilayer ceramic capacitor of claim 7, wherein:
a sum of the number of internal electrodes in the first outer region and the number of internal electrodes in the second outer region is smaller than the number of internal electrodes in the inner region.

9. The multilayer ceramic capacitor of claim 1, wherein:
the body further includes:
a first cover layer disposed an outer surface of the first outer region in the first direction; and
a second cover layer disposed on outer surface of the second outer region in the first direction.

10. The multilayer ceramic capacitor of claim 1, further comprising:
a plating layer that covers the external electrode.

11. The multilayer ceramic capacitor of claim 10, wherein:
the plating layer includes:
a first layer that covers the external electrode;
a second layer that covers the first layer; and
a third layer that covers the second layer.

12. The multilayer ceramic capacitor of claim 11, wherein:
the first layer contains nickel (Ni),
the second layer contains copper (Cu), and
the third layer contains tin (Sn).

13. The multilayer ceramic capacitor of claim 2, the thickness of the dielectric layer in the inner region is 0.88 μm, and the thickness of the dielectric layer in the first outer region is 0.93 μm.

14. The multilayer ceramic capacitor of claim 3, the thickness of the dielectric layer in the inner region is 0.88 μm, and the thickness of the dielectric layer in the second outer region is 0.93 μm.
